(19) United States
(12) Patent Application Publication
(10) Pub. No.: US 2026/0111745 A1
(43) Pub. Date: Apr. 23, 2026

(54) TOKEN AUGMENTATION FOR TRAINING MULTIMODAL LARGE LANGUAGE MODELS

(71) Applicant: Google LLC, Mountain View, CA (US)

(72) Inventors: Fadi Biadsy, Sandyston, NJ (US); Yonghui Xiao, Mountain View, CA (US)

(73) Assignee: Google LLC, Mountain View, CA (US)

(21) Appl. No.: 19/365,115

(22) Filed: Oct. 21, 2025

Related U.S. Application Data
(60) Provisional application No. 63/710,428, filed on Oct. 22, 2024.

(51) Int. Cl. G06N 3/09; G06N 3/0475

(52) U.S. Cl. CPC G06N 3/09; G06N 3/0475

(57) ABSTRACT

A method for training a large language model (LLM) includes obtaining training data including a plurality of training samples. Each corresponding training sample includes a corresponding task prompt specifying a task for the LLM to perform, a corresponding input token sequence, and a corresponding ground-truth output token sequence. For each corresponding training sample, the method also includes randomizing the corresponding input token sequence to generate a randomized input token sequence, processing, using the LLM, the randomized input token sequence conditioned on the corresponding task prompt to generate a predicted sequence of output tokens characterizing a response, and generating, based on the predicted sequence of output tokens and the corresponding ground-truth output token sequence, a corresponding loss function. The method also includes training the LLM based on the corresponding loss functions.

### CROSS-REFERENCE TO RELATED APPLICATIONS

This U.S. patent application claims priority under 35 U.S.C. § 119(e) to U.S. Provisional Application 63/710,428, filed on Oct. 22, 2024. The disclosure of this prior application is considered part of the disclosure of this application and is hereby incorporated by reference in its entirety.

### TECHNICAL FIELD

This disclosure relates to multimodal large language models (LLMs).

### BACKGROUND

Large language models (LLMs) are increasingly used to perform complex language-based tasks, such as speech recognition or transcription, or text recognition, summarization, translation, prediction, understanding, processing, or generation.

### SUMMARY

One aspect of the disclosure provides a computer-implemented method that when executed on data processing hardware causes the data processing hardware to perform operations for training a large language model (LLM). The operations include obtaining training data including a plurality of training samples that each include a corresponding task prompt specifying a task for the LLM to perform, a corresponding input token sequence, and a corresponding ground-truth output token sequence. For each particular training sample of the plurality of training samples, the operations also include: randomizing the corresponding input token sequence to generate a randomized input token sequence comprising one or more randomized input tokens; processing, using the LLM, the randomized input token sequence conditioned on the corresponding task prompt to generate a predicted sequence of output tokens characterizing a response to the task specified by the corresponding task prompt; and generating, based on the predicted output token sequence and the corresponding ground-truth output token sequence, a corresponding loss function. The operations also include training the LLM based on the corresponding loss functions to learn how to predict the corresponding ground-truth output token sequences.

Implementations of the disclosure may include one or more of the following optional features. In some implementations, the corresponding input token sequence of the particular training sample is generated by: receiving a sequence of input features representing object data; processing, using an encoder, the sequence of input features to generate a sequence of encodings; and processing, using a Softmax function, the sequence of encodings to generate the corresponding input token sequence. The LLM may include a multimodal LLM.

In some examples, randomizing the corresponding input token sequence to generate the randomized input token sequence includes: copying one or more input tokens from the corresponding input token sequence to the randomized input token sequence; selecting, based on a first probability function, a subset of the one or more input tokens; and for each particular input token of the subset of the one or more input tokens, performing at least one of the following operations based on a second probability function. The operations include replacing the particular training input token with a random token in the randomized input token sequence, deleting the particular input token from the randomized input token sequence, inserting one or more random input tokens into the randomized input token sequence prior to or following the particular input token in the randomized input token sequence, replacing a string of input tokens including the particular input token with a string of random tokens in the randomized input token sequence, or deleting a string of training tokens including the particular input token from the randomized input token sequence. In these examples, the second probability function may include a Bernoulli probability function.

In some implementations, the operations also include obtaining previous output tokens generated by the LLM and randomizing one or more of the previous output tokens to generate an additional input token sequence. Here, processing, using the LLM, the randomized input token sequence to generate the predicted output token sequence includes processing, using the LLM, the randomized input token sequence and the additional input token sequence conditioned on the task prompt to generate the predicted sequence of output tokens.

The LLM may include a multimodal LLM. The LLM may include a plurality of multi-head attention layers. For instance, the LLM may include a plurality of Transformer layers, Conformer layers, or other type of multi-head attention layers.

In some examples, a particular training sample of the plurality of training samples includes corresponding training audio data and the corresponding input token sequence for the particular training sample includes a sequence of input tokens generated by processing the corresponding training audio data using an audio encoder. In some additional examples, a particular training sample of the plurality of training samples includes corresponding training image data and the corresponding input token sequence for the particular training sample includes a sequence of input tokens generated by processing the corresponding training image data using an image encoder. In some additional examples, a particular training sample of the plurality of training samples includes corresponding training audio-visual data and the corresponding input token sequence for the particular training sample includes a sequence of input tokens generated by processing the corresponding training audio-visual data using an audio-visual encoder.

Another aspect of the disclosure provides a system that includes data processing hardware and memory hardware storing instructions that when executed on the data processing hardware causes the data processing hardware to perform operations for training a large language model (LLM). The operations include obtaining training data including a plurality of training samples that each include a corresponding task prompt specifying a task for the LLM to perform, a corresponding input token sequence, and a corresponding ground-truth output token sequence. For each particular training sample of the plurality of training samples, the operations also include: randomizing the corresponding input token sequence to generate a randomized input token sequence comprising one or more randomized input tokens; processing, using the LLM, the randomized input token sequence conditioned on the corresponding task prompt to generate a predicted sequence of output tokens characterizing a response to the task specified by the corresponding task prompt; and generating, based on the predicted output token sequence and the corresponding ground-truth output token sequence, a corresponding loss function. The operations also include training the LLM based on the corresponding loss functions to learn how to predict the corresponding ground-truth output token sequences.

Implementations of the disclosure may include one or more of the following optional features. In some implementations, the corresponding input token sequence of the particular training sample is generated by: receiving a sequence of input features representing object data; processing, using an encoder, the sequence of input features to generate a sequence of encodings; and processing, using a Softmax function, the sequence of encodings to generate the corresponding input token sequence. The LLM may include a multimodal LLM.

In some examples, randomizing the corresponding input token sequence to generate the randomized input token sequence includes: copying one or more input tokens from the corresponding input token sequence to the randomized input token sequence; selecting, based on a first probability function, a subset of the one or more input tokens; and for each particular input token of the subset of the one or more input tokens, performing at least one of the following operations based on a second probability function. The operations include replacing the particular training input token with a random token in the randomized input token sequence, deleting the particular input token from the randomized input token sequence, inserting one or more random input tokens into the randomized input token sequence prior to or following the particular input token in the randomized input token sequence, replacing a string of input tokens including the particular input token with a string of random tokens in the randomized input token sequence, or deleting a string of training tokens including the particular input token from the randomized input token sequence. In these examples, the second probability function may include a Bernoulli probability function.

In some implementations, the operations also include obtaining previous output tokens generated by the LLM and randomizing one or more of the previous output tokens to generate an additional input token sequence. Here, processing, using the LLM, the randomized input token sequence to generate the predicted output token sequence includes processing, using the LLM, the randomized input token sequence and the additional input token sequence conditioned on the task prompt to generate the predicted sequence of output tokens.

The LLM may include a multimodal LLM. The LLM may include a plurality of multi-head attention layers. For instance, the LLM may include a plurality of Transformer layers, Conformer layers, or other type of multi-head attention layers.

In some examples, a particular training sample of the plurality of training samples includes corresponding training audio data and the corresponding input token sequence for the particular training sample includes a sequence of input tokens generated by processing the corresponding training audio data using an audio encoder. In some additional examples, a particular training sample of the plurality of training samples includes corresponding training image data and the corresponding input token sequence for the particular training sample includes a sequence of input tokens generated by processing the corresponding training image data using an image encoder. In some additional examples, a particular training sample of the plurality of training samples includes corresponding training audio-visual data and the corresponding input token sequence for the particular training sample includes a sequence of input tokens generated by processing the corresponding training audio-visual data using an audio-visual encoder.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system using a multimodal large language model (LLM) for performing tasks.

FIG. 2 is a schematic view of an example training process for training a multimodal LLM using token augmentation.

FIG. 3 is a flowchart of an example arrangement of operations for a method of training a multimodal LLM using token augmentation.

FIG. 4 is a schematic view of an example computing device that may be used to implement the systems and methods described herein.

Like reference symbols in the various drawings indicate like elements.

### DETAILED DESCRIPTION

Large language models (LLMs) are used in diverse applications involving language, from speech and text recognition to summarization, translation, and text generation. These models operate by processing input prompts, which are first tokenized, to predict subsequent tokens. Due to the vast combinatorial space of possible token sequences, even extensive training datasets expose LLMs to only a minuscule fraction of all possible subsequences. This limited exposure can compromise an LLM's robustness when encountering novel or unfamiliar input during inference, potentially leading to undesirable outcomes such as hallucination. Considering a token vocabulary of 250,000, the number of possible sequences of length N, 250,000\hat{ }N, quickly becomes astronomically large. While large text corpora might mitigate this issue for purely text-based LLMs by enabling them to identify unfamiliar token sequences, multimodal LLMs face a greater challenge. These models process audio and/or video inputs by tokenizing the continuous signal, but sufficiently large training datasets for these modalities are often unavailable. Furthermore, minor alterations in an audio/video signal can generate entirely new token sequences, increasing the risk of hallucination. Consequently, there is a clear demand for token augmentation strategies to expand the effective volume of audio/video training data for multimodal LLMs.

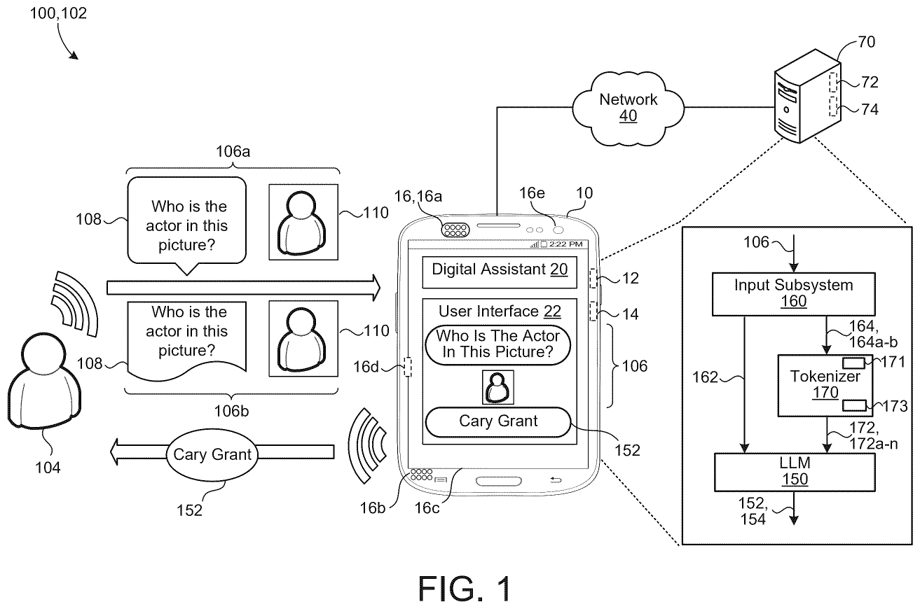

FIG. 1 is a schematic view of an example system 100 that includes a multimodal LLM 150 (also referred to herein as LLM 150) for performing any of a variety of tasks within an environment 102. The system 100 includes a user device 10 interacting with a user 104 to perform tasks using the LLM 150. In some examples, a digital assistant interface 20 (or simply digital assistant 20) executes on the user device 10 and the user 104 interacts with the digital assistant 20 by providing user inputs 106, 106a-n that specify tasks for the LLM 150 to perform. Example tasks that may be specified by the user input 106 for the LLM 150 to perform include, without limitation, a request, prompt, or query for the LLM 150 to: answer a question, summarize text or contents of a document, describe an image, identify an object in an image, classify an image, identify audio or sound, classify audio or sound, identify a video, classify a video, identify information or metadata associated with audio, identify information or metadata associated with an image, identify information or metadata associated with a video, generate audio, generate an image, generate a video, translate content written/spoken in one language into one or more other languages, analyze sentiment/understanding of text, facilitate conversation (e.g. via the digital assistant 22) with the user 104, or generate continuation text that completes a sentence, to name some. The LLM 150 may power the digital assistant 20.

In FIG. 1, the user 104 may provide, among possibly other forms or types of inputs, multimodal user inputs 106 that include a task prompt portion 108 and an object data portion 110. Here, the user prompts the LLM 150 to perform a task specified by the task prompt portion 108 on, or based on, the object data portion 110. In the example shown, the user 104 prompts the LLM 150 to identify an actor in an image 110. The user 104 may provide the task prompt portion 108 in the form of, for example: text-based user input (e.g., typed inputs) or speech-based user input (e.g., spoken utterances) that include audio data characterizing an utterance spoken by the user 104. The task prompt portion 108 characterizes a natural language prompt that specifies a task the user 104 wants the LLM 150 to perform on behalf of the user 104. Audio data representing a spoken task prompt portion 108 may be processed using an automatic speech recognition (ASR) system (not shown) to generate a corresponding text-based prompt portion 108 that may be input to the LLM 150 as a task prompt 162. Alternatively, audio data representing a spoken task prompt portion 108 may be processed using an audio encoder (not shown), and the LLM 150 may decode the audio encodings output form the audio encoder that represent the spoken task prompt portion to generate a corresponding text-based prompt portion 108 that may then be input back into the LLM 150 as a task prompt 162.

The object data portion 110 may include, for example, any form of audio data, image data, video data, and/or audio-visual data (e.g., a combination of audio data and video data) provided by the user 104. In some examples, the object data portion 110 (e.g., an image) is stored on the user device 10 (or stored on data storage in communication with the user device 10) and the user 104 recalls the data from storage and inputs the data together with the task prompt portion 108 to form the multimodal input 106 to the LLM 150. Alternatively, the data of the object data portion 110 may be captured by the user device 10 as the user provides the task prompt portion 108 to the LLM 150.

Responses 152 (i.e., a sequences of output tokens 154) generated by the LLM 150 and returned to the user 104 may indicate performance of the tasks specified by the corresponding task prompts 162. The digital assistant 20 may provide the sequence of output tokens 154 as, for example, text for presentation in the digital assistant interface 22 displayed on a screen 16c of the user device 10 and/or as synthesized speech audibly output by an audio output device 16b (e.g., a speaker) of the user device 10. In some examples, a sequence of output tokens 154 generated by the LLM 150 as a corresponding response 152 to a task prompt 162 is represented by a sequence of text, or a text-to-speech (TTS) system (not shown for clarity of illustration) may convert the sequence of text into synthesized speech that conveys the response 152. In some configurations, the LLM 150 generates a sequence of output tokens 154 that includes synthesized speech features (e.g., mel-frequency spectrograms) to be converted by a synthesizer (not shown) into synthesized speech characterizing the response 152 to the task prompt 162. In the example shown, the user 104 provides a user input 106 including a task prompt portion 108 that prompts the LLM 150 to answer the question “Who is the actor in this picture?” and an image 110 depicting the picture of the actor, and the LLM 150 answers the question by returning a response 152 of “Cary Grant”.

The LLM 150 may be any multimodal LLM capable of processing, for example, text inputs, speech-based inputs, image inputs, audio inputs, video inputs, and audio-visual inputs. For example, the LLM 150 may include a plurality of multi-head attention layers. Here, the multi-head attention layers may include Transformer layers, Conformer layers, or any other type of multi-head attention layers. In some implementations, the LLM 150 includes any of the LLM models described by Google Inc., the Applicant of the Present Application, in “Gemini: A Family of Highly Capable Multimodal Models,” which was first published in Dec. 19, 2023, at https://arxiv.org/abs/2312.11805, the contents of which are incorporated herein in its entirety. The LLM 150 may be, or include, a portion of a memory unit (e.g., the memory hardware 14 or 74) configured to store software and/or machine-or computer-readable instructions that, when executed by a processing unit (e.g., the data processing hardware 12 or 72)), cause the LLM 150 to predict a sequence of output tokens 154 based on a multimodal user input 106.

The user device 10 may correspond to any computing device associated with a user 104 and capable of capturing user inputs 106 and providing, in response, text, image, audio or video outputs. Some examples of user devices 10 include, but are not limited to, mobile devices (e.g., mobile phones, tablets, laptops, etc.), computers, wearable devices (e.g., a smart watch, smart glasses, smart goggles, an augmented reality (AR) headset, a virtual reality (VR) headset, etc.), smart appliances, Internet of things (IoT) devices, vehicle infotainment systems, smart displays, smart speakers, etc. The user device 10 includes data processing hardware 12 and memory hardware 14 in communication with the data processing hardware 12 and storing instructions, that when executed by the data processing hardware 12, causes the data processing hardware 12 to perform one or more operations.

The user device 10 further includes, or is in communication with, one or more input/output devices 16, 16a-n, such as: an audio capture device 16a (e.g., an array of one or more microphones) for capturing and converting audio into electrical signals; the audio output device 16b (e.g., a speaker) for converting electrical signals into audio; the screen 16c for presenting visual content; a physical or virtual keyboard 16d for capturing text inputs; or an image/video capture device 16e (e.g., a camera) for capturing and converting an image or video into electrical signals. Of course, any number and/or type(s) of other input/output devices 16 may be used. The input/output devices 16 may reside on or be in communication with the user device 10. The digital assistant interface 22 may execute on the data processing hardware 12 for display on the screen 16c.

The system 100 includes an input subsystem 160 configured to receive user inputs 106 captured by input devices 16. For each user input 106, the input subsystem 160 outputs a task prompt 162 representative of the prompt portion 108 the user input 106, and input features 164, 164a-n representative of the object data portion 110 of the user input 106. Here, the task prompt 162 specifies a task for the LLM 150 to perform on, or based on, the input features 164. The input subsystem 160 may include an ASR system for converting a spoken task prompt portion 108 into a corresponding text-based prompt portion 108 for input to the LLM 150 as the task prompt 162. The input subsystem 160 may additionally include an input method editor (IME) for input the multimodal user inputs 106 that include the task prompt portion 108 and the object data portion 110,

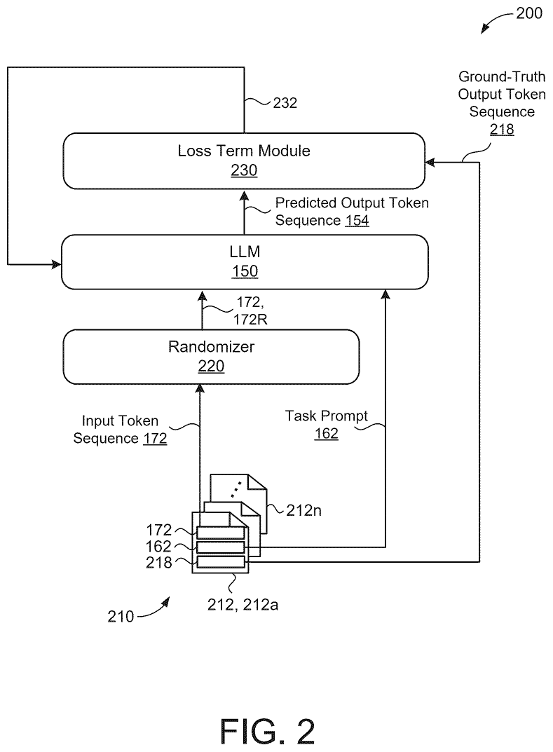

The system 100 includes a tokenizer 170 configured to process the input features 164 representing the object data portion 110 to generate one or more input tokens 172, 172a-n on which the LLM 150 is to perform the task prompt 162. The input tokens 172 (also referred to as ‘input token sequence’) may include discrete tokens. In some implementations, the tokenizer 170 includes an encoder 171 that processes the input tokens to generate one or more encodings, and a Softmax function 173 that processes the encodings to generate one or more input tokens 172 conditioned on the task prompt 162. Example encoders 171 include an audio encoder, an image encoder, and a video encoder. However, other tokenizers 170 may be used. In some implementations, the sequence of input tokens 172 conditioned on the task prompt 162 are randomized before processing by the LLM 150. Example methods of randomizing the sequence of input tokens 172 conditioned on the task prompt 162 are described below in connection with the randomizer 220 of FIG. 2.

Any combination of the LLM 150, the input subsystem 160, and the tokenizer 170 may execute on the user device 10 and/or on a remote computing system 70 (e.g., one or more remote servers of a distributed system executing in a cloud-computing environment) in communication with the user device 10 via a network 40. The remote computing system 70 includes data processing hardware 72 and memory hardware 74 in communication with the data processing hardware 72. The memory hardware 74 stores instructions that, when executed by the data processing hardware 72, cause the data processing hardware 72 to perform one or more operations, such as operations disclosed herein.

FIG. 2 is a schematic view of an example training process 200 for training the multimodal LLM 150 using token augmentation. The training process 200 may execute on the remote computing system 70 (i.e., on the data processing hardware 72) or on the user device 10 (i.e., on the data processing hardware 12). In the example shown, the training process 200 trains the LLM 150 using a training data set 210 that includes a plurality of training samples 212, 212a-n. Here, each corresponding training sample 212 of the plurality of training samples 212 includes a corresponding task prompt 162, a corresponding input token sequence 172 of one or more input tokens conditioned on the task prompt 162, and a corresponding ground-truth output token sequence 218 for the corresponding training sample 212. As will become apparent, the ground-truth output token sequence 218 characterizes a response 152 the training process 200 is teaching the LLM 150 to learn how to predict/generate based on the corresponding input token sequence 172 conditioned on the corresponding task prompt 162.

When, for example, a training sample 212 includes training audio data, an audio encoder 171 (FIG. 1) and Softmax function 173 (FIG. 1) of the tokenizer 170 (FIG. 1) may generate the corresponding input token sequence 172 conditioned on the task prompt 162 by processing the training audio data. Similarly, when, for example, a training sample 212 includes training image data, an image encoder 171 (FIG. 1) and Softmax function 173 (FIG. 1) of the tokenizer 170 (FIG. 1) may generate the corresponding input token sequence 172 conditioned on the task prompt 162 by processing the training image data. Likewise, when, for example, a training sample 212 includes training audio-visual data, an audio-visual encoder 171 (FIG. 1) and Softmax function 173 (FIG. 1) of the tokenizer 170 (FIG. 1) may generate the corresponding input token sequence 172 conditioned on the task prompt 162 by processing the training audio-visual data.

In some examples, for each corresponding training sample 212 in the training data set 210, the training process 200 processes, using a randomizer 220, the corresponding input token sequence 172 to generate a randomized input token sequence 172, 172R that includes one or more randomized input tokens. The training process 200 then processes, using the LLM 150, the randomized input token sequence 172R conditioned on the task prompt 162 to generate a predicted sequence of output tokens 154 characterizing a corresponding response 152 to the task specified by the task prompt 214. A loss term module 230 determines a loss 232 based on the corresponding ground-truth token sequence 218 and the predicted sequence of output tokens 154. In some examples, the loss 232 represents a number of token errors between the corresponding ground-truth token sequence 218 and the predicted sequence of output tokens 154.

Thereafter, the training process 200 trains the LLM 150 based on the losses 232 to teach the LLM 150 to learn how to predict the corresponding ground-truth output token sequences 218 based on the corresponding input token sequences 172 conditioned on the corresponding task prompts 162. In some examples, the training process 200 trains the LLM 150 by adjusting, adapting, updating, fine-tuning, etc. one or more parameters or weights of the LLM 150 based on the losses 232. Additionally or alternatively, the training process 200 may train the LLM 150 by training one or more adapter modules/layers implemented by the LLM 150.

In some examples, the randomizer 220 generates the randomized input sequence 172R by copying the one or more training input tokens of the corresponding input token sequence 172 to the randomized input token sequence 172R, and selecting, based on a first probability function, a subset of the one or more training input tokens. Then, for each corresponding training input token of the subset of the one or more training input tokens, the randomizer 220, based on a second probability function, at least one of: replaces the corresponding training input token with a random token in the randomized input token sequence 172R; deletes the corresponding training input token from the randomized input token sequence 172R, inserts one or more random input tokens into the randomized input token sequence prior to or following the corresponding training input token in the randomized input token sequence 172R; replaces a string of training input tokens including the corresponding training input token with a string of random tokens in the randomized input token sequence 172R; or deletes a string of training input tokens including the corresponding training input token from the randomized input token sequence 172R. An example second probability function includes a Bernoulli probability function.

In some implementations, the training process 200 obtains previous output tokens 154 generated by the LLM 150 for a previous task prompt 162, and the randomizer 220 randomizes one or more of the previous output tokens 154 to generate a sequence of additional input tokens that includes one or more randomized tokens. Here, the training process 200 processes, using the LLM 150, the corresponding training input token sequence 172 and the sequence of additional input tokens conditioned on the current task prompt 162 to generate the predicted sequence of output tokens 154 for the current task prompt 162.

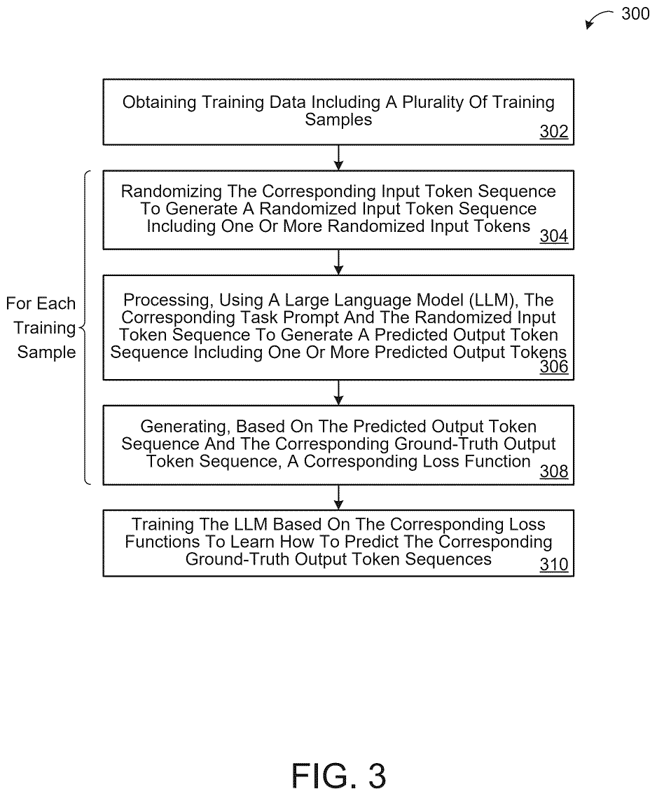

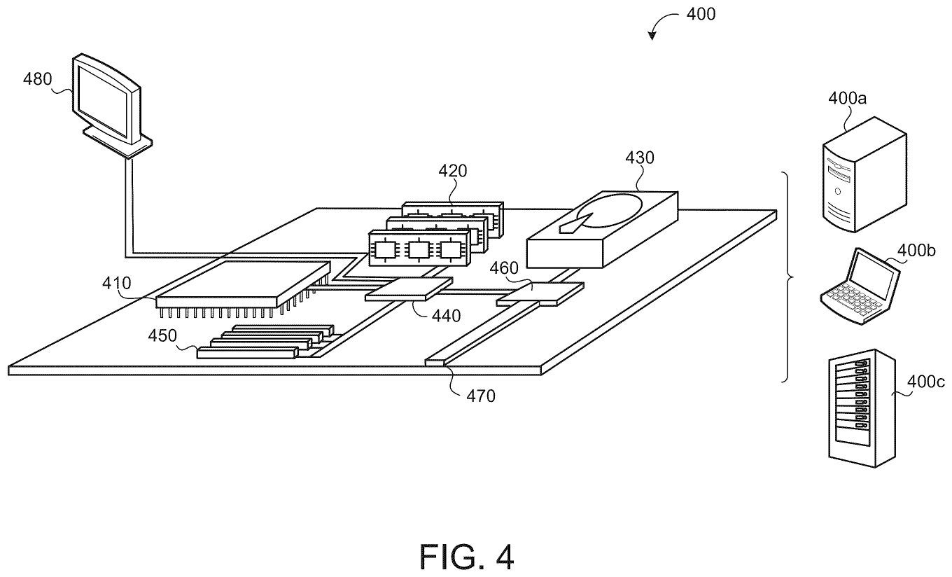

FIG. 3 is a flowchart of an exemplary arrangement of operations for a computer-implemented method 300 of training the multimodal LLM 150 using token augmentation. The operations may be performed by data processing hardware 410 (FIG. 4) (e.g., the data processing hardware 12 of the user device 10 or the data processing hardware 72 of the remote computing system 70) based on executing instructions stored on memory hardware 420 (e.g., the memory hardware 14 of the user device 10 or the memory hardware 74 of the remote computing system 70). Many other ways of implementing the method 300 may be employed. For example, the order of execution of the operations may be changed, and/or one or more of the operations and/or interactions may be changed, eliminated, sub-divided, or combined. Additionally, the operations of FIG. 3 may be carried out sequentially and/or in parallel by, for example, separate processing threads, processors, devices, discrete logic, circuits, etc.

At operation 302, the method 300 includes obtaining a training data set 210 including a plurality of training samples 212. Here, each corresponding training sample 212 of the plurality of training samples 212 includes a corresponding task prompt 162, a corresponding input token sequence 172, and a corresponding ground-truth output token sequence 218.

At operation 304, for each corresponding training sample 212 of the plurality of training samples 212, the method 300 includes randomizing the corresponding input token sequence 172 to generate a randomized input token sequence 172R that includes one or more randomized input tokens. At operation 306, for each corresponding training sample 212 of the plurality of training samples 212, the method 300 includes processing, using the LLM 150, the randomized input token sequence 172R conditioned on the task prompt 162 to generate a predicted sequence of output tokens 154 that characterizes a response 152 to the task specified by the task prompt 162. At operation 308, for each corresponding training sample 212 of the plurality of training samples 212, the method 300 includes generating, based on the predicted output token sequence 152 and the corresponding ground-truth output token sequence 218, a corresponding loss function 232.

At operation 310, the method 300 includes training the LLM 150 based on the corresponding loss functions 232 to learn how to predict the corresponding ground-truth output sequences 218. In some examples, training the LLM 150 includes adjusting, adapting, updating, fine-tuning, etc. one or more parameters or weights of the LLM 150 based on the losses 232.

FIG. 4 is schematic view of an example computing device 400 that may be used to implement the systems and methods described in this document. The computing device 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 400 includes a processor 410 (i.e., data processing hardware) that can be used to implement the data processing hardware 12 and/or 72, memory 420 (i.e., memory hardware) that can be used to implement the memory hardware 14 and/or 74, a storage device 430 (i.e., memory hardware) that can be used to implement the memory hardware 14 and/or 74, a high-speed interface/controller 440 connecting to the memory 420 and high-speed expansion ports 450, and a low speed interface/controller 460 connecting to a low speed bus 470 and a storage device 430. Each of the components 410, 420, 430, 440, 450, and 460, are interconnected using various busses, and may be mounted on a common motherboard or in other manners as appropriate. The processor 410 can process instructions for execution within the computing device 400, including instructions stored in the memory 420 or on the storage device 430 to display graphical information for a graphical user interface (GUI) on an external input/output device, such as display 480 coupled to high-speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 420 stores information non-transitorily within the computing device 400. The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random-access memory (RAM), dynamic random-access memory (DRAM), static random-access memory (SRAM), phase-change memory (PCM) as well as disks or tapes.

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 420, the storage device 430, or memory on processor 410.

The high-speed controller 440 manages bandwidth-intensive operations for the computing device 400, while the low-speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C. Furthermore, unless expressly stated to the contrary, “A or B” is intended to refer to any combination of A and B, such as: (1) A alone; (2) B alone; and (3) A and B.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
obtaining training data comprising a plurality of training samples, each corresponding training sample of the plurality of training samples comprising:
a corresponding task prompt specifying a task for a large language model (LLM) to perform;
a corresponding input token sequence; and
a corresponding ground-truth output token sequence;
for each corresponding training sample of the plurality of training samples:
randomizing the corresponding input token sequence to generate a randomized input token sequence comprising one or more randomized input tokens;
processing, using the LLM, the randomized input token sequence conditioned on the corresponding task prompt to generate a predicted sequence of output tokens characterizing a response to the task specified by the corresponding task prompt; and
generating, based on the predicted sequence of output tokens and the corresponding ground-truth output token sequence, a corresponding loss function; and
training the LLM based on the corresponding loss functions to learn how to predict the corresponding ground-truth output token sequences.

2. The computer-implemented method of claim 1, wherein the corresponding input token sequence of the corresponding training sample is generated by:
receiving a sequence of input features representing object data;
processing, using an encoder, the sequence of input features to generate a sequence of encodings; and
processing, using a Softmax function, the sequence of encodings to generate the corresponding input token sequence.

3. The computer-implemented method of claim 1, wherein the LLM comprises a multimodal LLM.

4. The computer-implemented method of claim 1, wherein randomizing the corresponding input token sequence to generate the randomized input token sequence comprises:
copying one or more input tokens from the corresponding input token sequence to the randomized input token sequence;
selecting, based on a first probability function, a subset of the one or more input tokens; and
for each corresponding input token of the subset of the one or more input tokens, performing at least one of the following operations based on a second probability function:
replacing the corresponding input token with a random token in the randomized input token sequence;
deleting the corresponding input token from the randomized input token sequence;
inserting one or more random input tokens into the randomized input token sequence prior to or following the corresponding input token in the randomized input token sequence;
replacing a string of input tokens including the corresponding input token with a string of random tokens in the randomized input token sequence; or
deleting a string of training tokens including the corresponding input token from the randomized input token sequence.

5. The computer-implemented method of claim 4, wherein the second probability function comprises a Bernoulli probability function.

6. The computer-implemented method of claim 1, wherein the operations further comprise:
obtaining previous output tokens generated by the LLM; and
randomizing one or more of the previous output tokens to generate an additional input token sequence,
wherein processing, using the LLM, the randomized input token sequence to generate the predicted sequence of output tokens comprises processing, using the LLM, the randomized input token sequence and the additional input token sequence conditioned on the task prompt to generate the predicted sequence of output tokens.

7. The computer-implemented method of claim 1, wherein the LLM comprises a plurality of multi-head attention layers.

8. The computer-implemented method of claim 1, wherein:
at least one training sample of the plurality of training samples comprises corresponding training audio data, and
the corresponding input token sequence for the at least one training sample comprises a sequence of input tokens generated by processing the corresponding training audio data using an audio encoder.

9. The computer-implemented method of claim 1, wherein:
at least one training sample of the plurality of training samples comprises corresponding training image data; and
the corresponding input token sequence for the at least one training sample comprises a sequence of input tokens generated by processing the corresponding training image data using an image encoder.

10. The computer-implemented method of claim 1, wherein:
at least one training sample of the plurality of training samples comprises corresponding training audio-visual data; and
the corresponding input token sequence for the at least one training sample comprises a sequence of input tokens generated by processing the corresponding training audio-visual data using an audio-visual encoder.

11. A system comprising:
data processing hardware; and
memory hardware in communication with the data processing hardware, the memory hardware storing instructions that, when executed on the data processing hardware, cause the data processing hardware to perform operations comprising:
obtaining training data comprising a plurality of training samples, each corresponding training sample of the plurality of training samples comprising:
a corresponding task prompt specifying a task for a large language model (LLM) to perform;
a corresponding input token sequence; and
a corresponding ground-truth output token sequence;
for each corresponding training sample of the plurality of training samples:
randomizing the corresponding input token sequence to generate a randomized input token sequence comprising one or more randomized input tokens;
processing, using the LLM, the randomized input token sequence conditioned on the corresponding task prompt to generate a predicted sequence of output tokens characterizing a response to the task specified by the corresponding task prompt; and
generating, based on the predicted sequence of output tokens and the corresponding ground-truth output token sequence, a corresponding loss function; and
training the LLM based on the corresponding loss functions to learn how to predict the corresponding ground-truth output token sequences.

12. The system of claim 11, wherein the corresponding input token sequence of the corresponding training sample is generated by:
receiving a sequence of input features representing object data;
processing, using an encoder, the sequence of input features to generate a sequence of encodings; and
processing, using a Softmax function, the sequence of encodings to generate the corresponding input token sequence.

13. The system of claim 11, wherein the LLM comprises a multimodal LLM.

14. The system of claim 11, wherein randomizing the corresponding input token sequence to generate the randomized input token sequence comprises:
copying one or more input tokens from the corresponding input token sequence to the randomized input token sequence;
selecting, based on a first probability function, a subset of the one or more input tokens; and
for each corresponding input token of the subset of the one or more input tokens, performing at least one of the following operations based on a second probability function:
replacing the corresponding input token with a random token in the randomized input token sequence;
deleting the corresponding input token from the randomized input token sequence,
inserting one or more random input tokens into the randomized input token sequence prior to or following the corresponding input token in the randomized input token sequence;
replacing a string of input tokens including the corresponding input token with a string of random tokens in the randomized input token sequence; or
deleting a string of training tokens including the corresponding input token from the randomized input token sequence.

15. The system of claim 14, wherein the second probability function comprises a Bernoulli probability function.

16. The system of claim 11, wherein the operations further comprise:
obtaining previous output tokens generated by the LLM; and
randomizing one or more of the previous output tokens to generate an additional input token sequence,
wherein processing, using the LLM, the randomized input token sequence to generate the predicted sequence of output tokens comprises processing, using the LLM, the randomized input token sequence and the additional input token sequence conditioned on the task prompt to generate the predicted sequence of output tokens.

17. The system of claim 11, wherein the LLM comprises a plurality of multi-head attention layers.

18. The system of claim 11, wherein:
at least one training sample of the plurality of training samples comprises corresponding training audio data; and
the corresponding input token sequence for the at least one training sample comprises a sequence of input tokens generated by processing the corresponding training audio data using an audio encoder.

19. The system of claim 11, wherein:
at least one training sample of the plurality of training samples comprises corresponding training image data; and
the corresponding input token sequence for the at least one training sample comprises a sequence of input tokens generated by processing the corresponding training image data using an image encoder.

20. The system of claim 11, wherein:
at least one training sample of the plurality of training samples comprises corresponding training audio-visual data; and
the corresponding input token sequence for the at least one training sample comprises a sequence of input tokens generated by processing the corresponding training audio-visual data using an audio-visual encoder.
